(19) United States
(12) Patent Application Publication
(10) Pub. No.: US 2025/0252548 A1
(43) Pub. Date: Aug. 7, 2025

(54) VIDEO ACQUISITION SUPPORT APPARATUS, VIDEO ACQUISITION SUPPORT METHOD, AND STORAGE MEDIUM STORING PROGRAM

(71) Applicant: EBARA CORPORATION, Tokyo (JP)

(72) Inventors: Shunsuke KAGAYA, Tokyo (JP); Yosuke NAGASAWA, Tokyo (JP)

(21) Appl. No.: 18/952,825

(22) Filed: Nov. 19, 2024

(30) Foreign Application Priority Data
Feb. 6, 2024 (JP) 2024-016076

(51) Int. Cl. G06T 7/00; H04N 7/18

(52) U.S. Cl. CPC G06T 7/0004; H04N 7/18

(57) ABSTRACT

Provided is a technology that can effectively acquire video of an operation of an operation screen of an operation device. A video acquisition support apparatus 40 includes a control module 950 configured to control an operation device 30. The control module executes a specific control process including: a video acquisition process configured to acquire a video of an operation of an operation screen 30a when an operator OP operates the operation screen 30a of the operation device; a meta information addition process configured to add meta information including at least an operation content operated by the operator on the operation screen to the acquired video; and a video storage process configured to store the acquired video in a storage device 952 together with the meta information added to the video.

### TECHNICAL FIELD

The present invention relates to a video acquisition support apparatus, a video acquisition support method, and a storage medium storing a program, and more specifically, to the video acquisition support apparatus for an operation screen of an operation device, the video acquisition support method, and the storage medium storing a program. This application claims priority from Japanese Patent Application No. 2024-016076 filed on Feb. 6, 2024. The entire disclosure including the descriptions, the claims, the drawings, and the abstracts in Japanese Patent Application No. 2024-016076 is herein incorporated by reference.

### BACKGROUND ART

Conventionally, for example, a substrate processing apparatus configured to process substrates has been known (see PTL 1). Specifically, this PTL 1 discloses the substrate processing apparatus configured to perform a plasma processing on the substrates. Conventionally, such substrate processing apparatuses include an operation device including an operation screen operated by an operator.

### CITATION LIST

### Patent Literature

PTL 1: Japanese Unexamined Patent Application Publication No. 2014-164482

### SUMMARY OF INVENTION

### Technical Problem

Generally, it takes a certain amount of time (training period) for operators to learn operations of an operation screen of an operation device. Hypothetically, if it were possible to effectively acquire videos of the operation of the operation screen, for example, by having operators watch these videos during the training period, the operators would be able to learn the operation of the operation screen more quickly. However, in the past, the technology that would enable the effective acquisition of the videos of such operations of the operation screen had not been sufficiently developed.

The present invention was made in view of the above, and one of its objectives is to provide a technology that can effectively acquire videos of an operation of an operation screen of an operation device.

### Solution to Problem

### (Aspect 1)

To achieve the above-described objective, a video acquisition support apparatus according to one aspect of the present invention is for an operation device including an operation screen operated by an operator. The video acquisition support apparatus includes a control module configured to control the operation device. The control module executes a specific control process that includes a video acquisition process, a meta information addition process, and a video storage process. The video acquisition process is configured to acquire a video of an operation of the operation screen when the operator operates the operation screen of the operation device. The meta information addition process is configured to add meta information including at least an operation content operated by the operator on the operation screen to the acquired video. The video storage process is configured to store the acquired video in a storage device together with the meta information added to the video.

According to the aspect, the videos of the operations on the operation screen of the operation device when the operator operates the operation screen can be stored in the storage device together with the meta information that includes at least the operation content operated by the operator on the operation screen. This allows the video of the operations on the operation screen of the operation device to be acquired effectively.

### (Aspect 2)

In the above-described aspect 1, the control module may execute the specific control process a plurality of times to store a plurality of the videos in the storage device; and a video display process in which the video related to the operation content is selected from among the plurality of videos stored in the storage device based on the operation content operated by the operator on the operation screen and displayed on the display device.

According to the aspect, the operator can learn the operation of the operation screen of the operation device more quickly by watching the videos displayed on the display device when operating the operation screen of the operation device.

### (Aspect 3)

In the above-described aspect 2, the display device may be configured to allow inputting of word, the meta information includes the word inputted, and the control module selects the video related to the word inputted and displays on the display device in the video display process.

### (Aspect 4)

In the above-described aspect 2 or 3, the display device may be configured to allow input of operator identification information for identifying the operator who operates the operation device, the meta information includes the operator identification information, and the control module selects the video related to the operator who operates the operation screen of the operation device based on the operator identification information in the video display process and displays on the display device.

### (Aspect 5)

In any one aspect of the above-described aspects 1 to 4, the control module may further execute an external video loading process configured to load an external video as a video of the operation of the operation screen of the operation device by the operator acquired by an external video acquisition device.

### (Aspect 6)

To achieve the above-described objective, a video acquisition support method according to one aspect of the present invention is for an operation device including an operation screen operated by an operator. The video acquisition support method includes: executing, by a control module configured to control the operation device, a video acquisition process configured to acquire a video of an operation of the operation screen when the operator operates the operation screen of the operation device; executing, by the control module, a meta information addition process configured to add meta information including at least an operation content operated by the operator on the operation screen to the acquired video; and executing, by the control module, a video storage process configured to store the acquired video in a storage device together with the meta information added to the video.

According to the aspect, the videos of the operations on the operation screen of the operation device when the operator operates the operation screen can be stored in the storage device together with the meta information that includes at least the operation contents operated by the operator on the operation screen. This makes it possible to effectively acquire the videos of the operations on the operation screen of the operation device.

### (Aspect 7)

To achieve the above-described objective, a storage medium according to one aspect of the present invention stores a program for causing a computer to execute a specific control process. The specific control process includes a video acquisition process, a meta information addition process, and a video storage process. The video acquisition process is configured to acquire a video of an operation of the operation screen when an operator operates an operation screen of an operation device. The meta information addition process is configured to add meta information including at least an operation content operated by the operator on the operation screen to the acquired video. The video storage process is configured to store the acquired video in a storage device together with the meta information added to the video.

### BRIEF DESCRIPTION OF DRAWINGS

FIG. 1 is a general layout drawing of a substrate processing apparatus according to an embodiment;

FIG. 2 is a schematic diagram illustrating an overall configuration of a video acquisition support apparatus according to the embodiment;

FIG. 3 is a schematic diagram illustrating one example of an operation screen of an operation device and a display screen of a display device according to the embodiment;

FIG. 4 is a schematic diagram illustrating one example of a change in the display screen of the display device according to the embodiment;

FIG. 5 is a schematic diagram illustrating one example of a list of operators according to the embodiment;

FIG. 6 is one example of a flowchart for describing a series of processes from a start of video acquisition to a storage of video according to the embodiment;

FIG. 7 is one example of a flowchart for describing a process for displaying the video on the display device according to the embodiment;

FIG. 8 is one example of a flowchart for describing a process for loading an external video according to Modification 1 of the embodiment; and

FIG. 9 is a schematic diagram illustrating one example of a hardware configuration of a control module according to the embodiment.

### DESCRIPTION OF EMBODIMENTS

The following describes embodiments of the present invention with reference to the drawings. Note that the drawings are schematically illustrated to facilitate understanding of features of an embodiment, and dimensional proportions and the like of each constituent element are not necessarily the same as the actual ones. In some drawings, orthogonal coordinates of X-Y-Z are illustrated for reference purposes. Among the orthogonal coordinates, the Z-direction corresponds to an upper side, and the −Z-direction corresponds to a lower side (direction in which gravity acts).

A video acquisition support apparatus 40 of an operation device 30 according to this embodiment is applied to a substrate processing apparatus 1, which is configured to process a substrate WF, as one example. In other words, the video acquisition support apparatus 40 of this embodiment is a video acquisition support apparatus for an operation screen 30a of the operation device 30 of the substrate processing apparatus 1. Therefore, first, an overview of the substrate processing apparatus 1 is described, and then a configuration of the video acquisition support apparatus 40 is described.

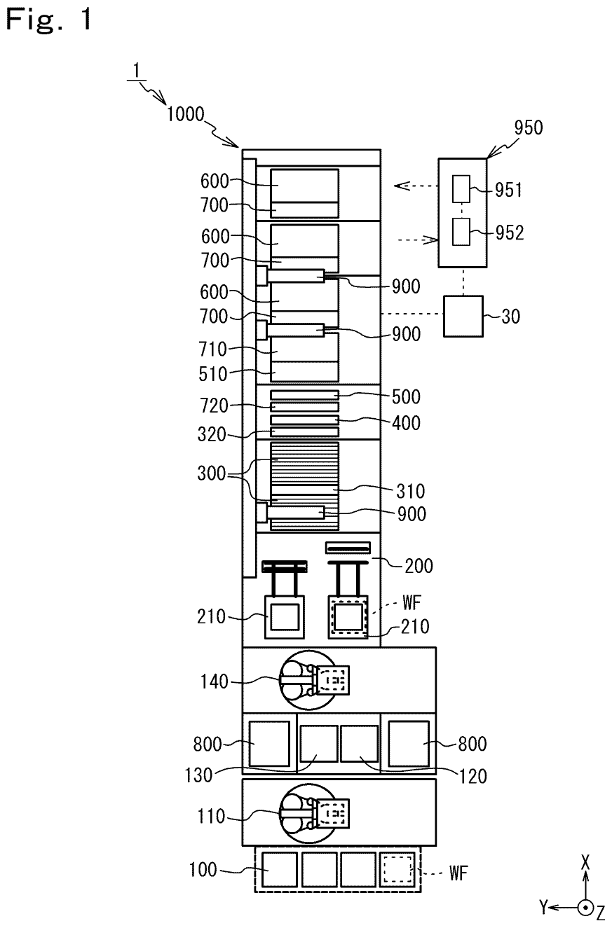

FIG. 1 is a general layout drawing illustrating the substrate processing apparatus 1 according to this embodiment. A specific type of the substrate processing apparatus 1 is not particularly limited to any apparatus as long as it is capable of processing the substrate WF, but in this embodiment, as one example of the substrate processing apparatus 1, a plating apparatus 1000 that applies a plating process on the substrate WF is used. However, the substrate processing apparatus 1 is not limited to the plating apparatus 1000, and as the substrate processing apparatus 1, a known substrate processing apparatus, for example, a polishing apparatus that performs a polishing process on the substrate WF or a plasma processing apparatus that performs a plasma process on the substrate WF, or the like can be used.

The plating apparatus 1000 illustrated in FIG. 1, as one example of the substrate processing apparatus 1, includes a load port 100, a transfer robot 110, a load stage 120, an unload stage 130, a loader 140, a fixing module 200, a stocker module 300, a swap module 310, a holder cleaning module 320, a pre-wet module 400, a pre-soak module 500, a pre-soak cleaning module 510, a plating module 600, a plating cleaning module 700, a blow module 710, a temporary placement module 720, a cleaning module 800, a transfer device 900, and a control module 950.

The load port 100 is a module for loading the substrate WF stored in a cassette such as a front opening unify pod (FOUP), which is not illustrated, into the plating apparatus 1000, and for unloading the substrate WF from the plating apparatus 1000 to the cassette. In this embodiment, the four load ports 100 are arranged side-by-side in a horizontal direction, but the number and the arrangement of the load ports 100 are arbitrary. The transfer robot 110 is a robot for horizontally transferring the substrates WF, and is configured to transfer the substrates WF between the load ports 100 and the load stage 120.

The load stage 120 is a stage for gripping or releasing the substrate WF before the plating process between the transfer robot 110 and the loader 140. The unload stage 130 is a stage for gripping or releasing the substrates WF after the plating process between the transfer robot 110 and the loader 140. The loader 140 is a robot for transferring the substrates WF horizontally, and is configured to transfer the substrate WF between the load stage 120, the unload stage 130, the fixing module 200, and the cleaning module 800.

The fixing module 200 is a module for attaching the substrate WF to a substrate holder 210 or removing the substrate WF from the substrate holder 210. The stocker module 300 is a module for storing the substrate holders 210 vertically. The swap module 310 is a module for temporarily storing the substrate holders 210 that need to be replaced or maintained, and is designed such that the substrate holders 210 can be inserted and removed. The substrate holder 210 removed from the swap module 310 can be maintained inside the plating apparatus 1000 or taken out of the plating apparatus 1000 for maintenance, and the substrate holder 210 after the maintenance or a new substrate holder 210 can be placed in the swap module 310. The holder cleaning module 320 is a module for cleaning the substrate holder 210.

The pre-wet module 400 is a module for wetting a surface to be plated of the substrate WF with a process liquid such as pure water or deaerated water before the plating process, in order to replace air inside a pattern formed on a substrate surface with the process liquid. The pre-wet module 400 is configured to perform a pre-wet process, which facilitates the supply of the plating solution to interior of the pattern by replacing the process liquid inside the pattern with the plating solution during the plating process.

The pre-soak module 500 is configured to perform a pre-soak process that cleans or activates a plating base surface by removing an oxide film having a high electrical resistance present on the surface of the seed layer or the like formed on the surface to be plated of the substrate WF before the plating process, by etching with a process liquid such as sulfuric acid and hydrochloric acid. The pre-soak cleaning module 510 is a module for cleaning the substrate WF having undergone the pre-soak process.

The plating module 600 is a module for performing the plating process on the substrate WF. The plating cleaning module 700 is a module for cleaning the substrate WF to remove the plating solution and the like remaining on the substrate WF after the plating process. In this embodiment, the three plating modules 600 and the plating cleaning modules 700 are arranged horizontally, but the numbers and the arrangements of the plating modules 600 and the plating cleaning modules 700 are arbitrary. The blow module 710 is a module for drying the substrate WF after the cleaning process. The temporary placement module 720 is a module for temporarily placing the substrate holder 210, to which the substrate WF is attached, for gripping or releasing between the plurality of transfer devices 900. In this embodiment, the temporary placement module 720 allows housing one substrate holder 210, but the number is arbitrary.

The cleaning module 800 is a module for applying the cleaning process and a drying process on the substrate WF in order to remove the plating solution and the like remaining on the substrate WF after the plating process, which has been removed from the substrate holder 210. In this embodiment, the two cleaning modules 800 are arranged horizontally across the load stage 120 and the unload stage 130, but the number and the arrangement of the cleaning modules 800 are arbitrary. The transfer device 900 is a device for vertically transferring the substrate holder 210 between a plurality of modules in the plating apparatus 1000. In this embodiment, the three transfer devices 900 are arranged side-by-side, but the number and the arrangement of the transfer devices 900 are arbitrary.

The control module 950 is configured to control the plurality of modules of the plating apparatus 1000, and can be configured, for example, from a general computer or a dedicated computer having an input/output interface with the operator.

One example of a series of plating processes with the plating apparatus 1000 is described. First, the substrate WF stored in the cassette is brought into the load port 100. Next, the transfer robot 110 takes the substrate WF out of the cassette in the load port 100 and places it on the load stage 120. The loader 140 receives the substrate WF from the load stage 120 and transfers it to the fixing module 200.

The fixing module 200 attaches the substrate WF to the substrate holder 210. The transfer device 900 transfers the substrate holder 210, to which the substrate WF is attached, to the pre-wet module 400. The pre-wet module 400 applies the pre-wet process on the substrate WF. The transfer device 900 transfers the substrate holder 210, to which the substrate WF having undergone the pre-wet process is attached, to the pre-soak module 500. The pre-soak module 500 performs the pre-soak process on the substrate WF. The transfer device 900 transfers the substrate holder 210, to which the substrate WF having undergone the pre-soak process is attached, to the pre-soak cleaning module 510. The pre-soak cleaning module 510 cleans the substrate WF. The transfer device 900 transfers the substrate holder 210, to which the substrate WF having undergone the cleaning process is attached, to the plating module 600. The plating module 600 performs the plating process on the substrate WF.

The transfer device 900 transfers the substrate holder 210, to which the substrate WF having undergone the plating process is attached, to the plating cleaning module 700. The plating cleaning module 700 applies the cleaning process on the substrate WF and the substrate holder 210. The transfer device 900 transfers the substrate holder 210, to which the substrate WF having undergone the cleaning process is attached, to the blow module 710. The blow module 710 applies the drying process on the substrate WF. The transfer device 900 transfers the substrate holder 210, to which the substrate WF having undergone the drying process is attached, to the temporary placement module 720, and another transfer device 900 transfers the substrate holder 210 from the temporary placement module 720 to the fixing module 200. The fixing module 200 removes the substrate WF from the substrate holder 210.

The loader 140 transfers the substrate WF after the plating process, which has been removed from the substrate holder 210, to the cleaning module 800. The cleaning module 800 applies the cleaning process and the drying process on the substrate WF. The loader 140 places the substrate WF, which has undergone the cleaning process and the drying process, on the unload stage 130. The transfer robot 110 receives the substrate WF from the unload stage 130 and transfers it to the cassette of the load port 100. Finally, the cassette housing the substrate WF is unloaded from the load port 100.

In the fixing module 200, the substrate holder 210, from which the substrate WF has been removed, is either attached to the next substrate WF or returned to the stocker module 300 by the transfer device 900. The substrate holder 210 that does not hold the substrate WF is cleaned in the holder cleaning module 320 as necessary.

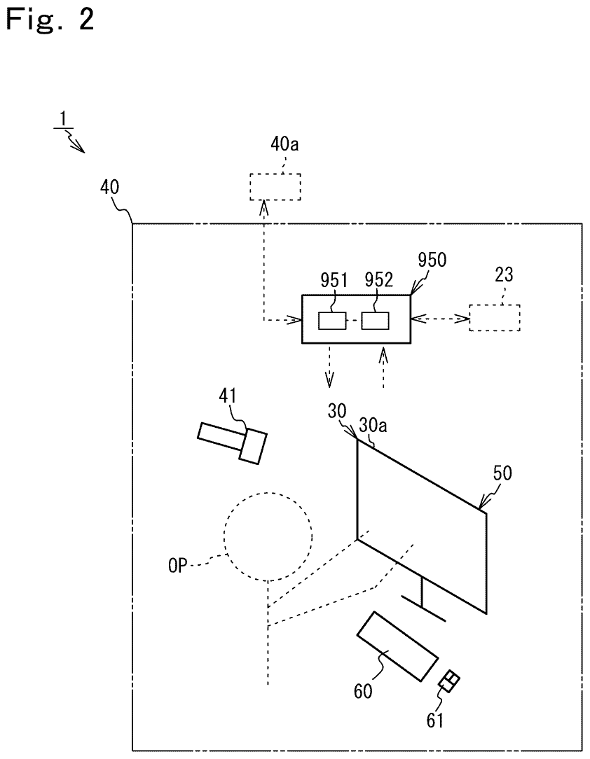

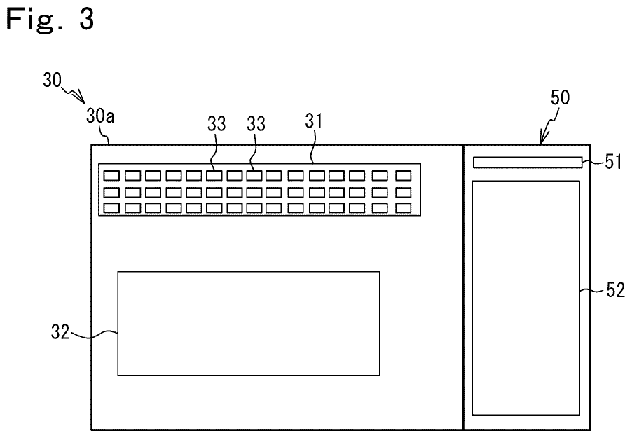

In addition, the substrate processing apparatus 1 (as one example, the plating apparatus 1000) according to this embodiment includes the operation device 30 that can be operated by an operator OP. Specifically, this operation device 30 includes the operation screen 30a that can be operated by the operator OP. One example of this operation screen 30a is illustrated in FIGS. 2 and 3 and the like, described later. The operation device 30 and the control module 950 are electrically connected. The operation information on the operation screen 30a of the operation device 30 is transmitted to the control module 950.

Details of this operation device 30 are described later.

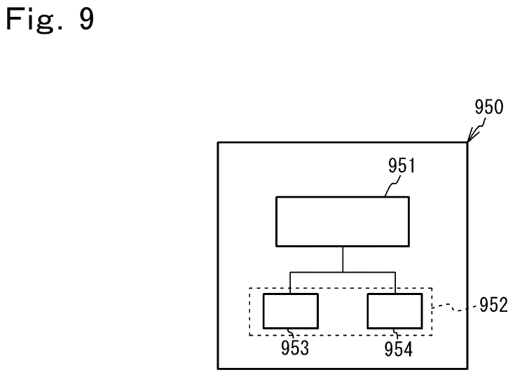

The control module 950 according to this embodiment includes a microcomputer. As illustrated in FIG. 9, the microcomputer of this control module 950 may include a processor 951, a storage device 952 as one example of a non-transitory storage medium, and the like. The storage device 952 may include, for example, a read only memory (ROM) 953 or a random access memory (RAM) 954, and the like. The control module 950 controls a portion to be controlled of the substrate processing apparatus 1 (as one example, the plating apparatus 1000) by having the processor 951 operate according to commands of the program stored in the storage device 952.

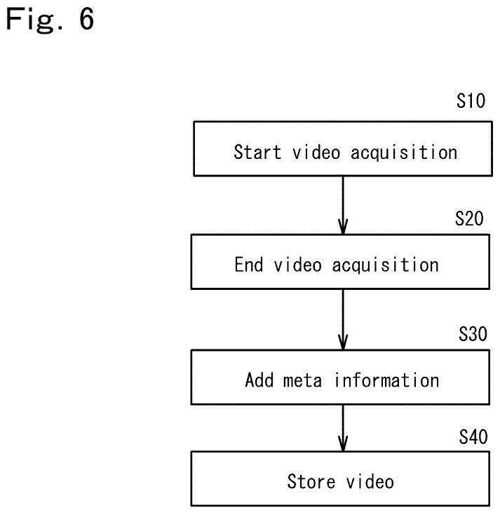

The respective steps in the flowcharts illustrated in FIGS. 6, 7, and 8 described later are implemented, for example, by having the program stored in the storage device 952 as one example of the storage medium executed by the control module 950 (specifically, the processor 951) as one example of the computer. The storage medium that stores this program may be any of a variety of known storage media, such as a compact disk read only memory (CD-ROM) or a Universal Serial Bus (USB) memory.

Furthermore, a configuration of the substrate processing apparatus 1 described above is just one example, and the configuration of the substrate processing apparatus 1 is not limited to the one described above. In addition, the substrate processing apparatus 1 according to this embodiment is configured to be able to switch between an “automatic mode” in which the above-described series of substrate processing (as one example, the plating process) is performed automatically under the control of the control module 950, and a “manual mode” in which the series of substrate processing is performed based on the operation of the operator OP.

Next, the video acquisition support apparatus 40 is described. FIG. 2 is a schematic diagram illustrating an overall configuration of the video acquisition support apparatus 40. FIG. 2 also schematically illustrates one example of how the operator OP is operating the operation screen 30a of the operation device 30 of the video acquisition support apparatus 40, which will be described later. FIG. 3 is a schematic diagram illustrating one example of the operation screen 30a of the operation device 30 and a display screen of a display device 50.

Referring to FIG. 2, the video acquisition support apparatus 40 includes the display device 50 and the control module 950. In addition, the video acquisition support apparatus 40 may include a shooting device 41, as illustrated in FIG. 2.

The shooting device 41 is configured to shoot a video of the operation of the operation screen 30a when the operator OP operates the operation screen 30a of the operation device 30. As the shooting device 41, for example, a publicly known camera capable of shooting video can be used. The shooting device 41 and the control module 950 are electrically connected. The operation of the shooting device 41 is controlled by the control module 950. The video acquired by the shooting device 41 are stored in the storage device 952, for example. This allows the control module 950 to acquire the video of the operation of the operation screen 30a.

In addition, the shooting device 41 may be fixed in a predetermined location (for example, a predetermined location in a building where the operation device 30 is located), as illustrated in FIG. 2. However, this configuration is not limited thereto, and for example, the shooting device 41 may be installed in a wearable accessory that can be worn by the operator OP (for example, a hat, a helmet, or goggles).

Furthermore, the method for capturing the video of the operation of the operation screen 30a of the operation device 30 is not limited to the method using the shooting device 41 described above. The control module 950 may acquire the video of the operation screen 30a of the operation device 30 by performing so-called “video capture process (or ‘screen capture process’)” instead of or in addition to the method using the shooting device 41.

This video capture process is a process that acquires and stores a series of image information displayed on a monitor as a video. This is a technology that is widely known in fields such as personal computers.

Referring to FIGS. 2 and 3, the display device 50 is a device for displaying predetermined information. The display device 50 and the control module 950 are electrically connected. The operation of the display device 50 is controlled by the control module 950. Information and the like input to the display device 50 is transmitted to the control module 950.

In this embodiment, as one example, the operation device 30 and the display device 50 are integrated. In addition, the operation device 30 (specifically, the operation screen 30a) and the display device 50 according to this embodiment are configured with a display that has, for example, a touch panel-type screen. In other words, in this case, a predetermined area of the display has a function of the operation screen 30a, and another predetermined area of the display has a function of the display device 50.

However, the above-described configuration is not limited thereto, and for example, the display device 50 may be configured as a separate device from the operation screen 30a of the operation device 30.

In addition, when capturing the operation video using the video capture process, the shooting device 41 (camera) is not required. In this case, the video acquisition support apparatus 40, the operation device 30, and the display device 50 may be configured, for example, by a single personal computer (for example, a personal computer with a display (the display device 50)). In addition, the video acquisition support apparatus 40 (or the personal computer as the video acquisition support apparatus 40) may further include, for example, a keyboard 60, and further include a mouse 61.

Referring to FIG. 2, the control module 950 according to this embodiment is, for example, a control module of the substrate processing apparatus 1 and also a control module of the video acquisition support apparatus 40. The control module 950 controls the operation device 30, the display device 50, and the shooting device 41 by having the processor 951 operate according to the commands of the program stored in the storage device 952. In addition, the video acquisition support apparatus 40 may be configured to have a control module dedicated to the video acquisition support apparatus 40, in addition to the control module dedicated to the substrate processing apparatus 1.

The video acquisition support apparatus 40 may include an “external storage device 23” that is separate from the storage device 952, as a “storage device” for storing the videos, and the like. This external storage device 23 may, for example, be a known storage device (such as a hard disk drive or a solid-state drive) or a known server. When using a server as the external storage device 23, this server may be connected to the control module 950 via the Internet, for example.

Referring to FIG. 3, the operation screen 30a of the operation device 30 according to this embodiment displays, as one example, at least an operation section 31 and a status display section 32.

The operation section 31 displays a plurality of operation icons 33. The plurality of operation icons 33 include “icon for starting operation” and “icon for ending operation” for respective component devices of the substrate processing apparatus 1. For example, when operating the substrate processing apparatus 1 in the manual mode, the operator OP can operate these icons to send commands for starting operation and stopping operation of the respective component devices of the substrate processing apparatus 1 to the control module 950.

The status display section 32 is configured to display, for example, an operating status and the like of the substrate processing apparatus 1. To give one example, the status display section 32 can display the name of a currently operating component device among the respective component devices of the substrate processing apparatus 1, or can illuminate the icon corresponding to this component device. This allows the operator OP to easily grasp what a component device is operating.

In addition, the status display section 32 may be configured to display an alarm, for example, if a problem occurs in the substrate processing apparatus 1.

As one example, the display device 50 is configured to display a word input section 51 and a display section 52.

The word input section 51 is configured such that the operator OP can input a predetermined word (for example a word for searching) using an input device such as a touch pen or the keyboard 60. Alternatively, the word input section 51 might not be configured to be displayed on the display device 50, but may be configured using the keyboard 60, for example.

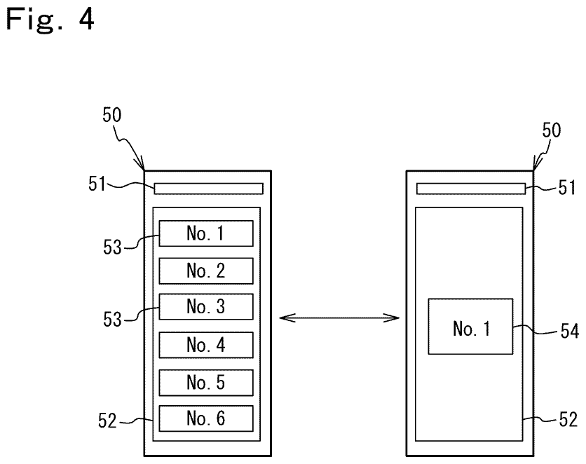

The display section 52 is configured to display at least a video. To give one example, as illustrated in FIG. 4, the display section 52 according to this embodiment is configured to display a list of a plurality of videos 53 (that is, video candidates). When the operator OP selects (or touches) a desired video 53 (for example, No. 1 video 53) from the list of the plurality of videos 53, the selected video is displayed on the display section 52.

Note that “selection by operator OP” is not limited to touching the screen in this way, and may also be carried out by clicking the mouse 61, for example (this is also the case in the following explanation).

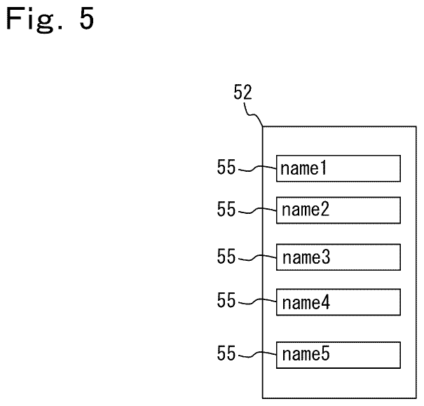

In addition, the display device 50 according to this embodiment is configured to allow the input of “operator identification information” to identify the operator OP who operates the operation device 30. For example, when the operator OP operates the predetermined operation icon 33 (the operation icon for displaying the operator list), a list of a plurality of operators 55, as illustrated in FIG. 5, are displayed on the display section 52, for example. The list of the plurality of operators 55 correspond to the “operator identification information.”

The operator OP selects (or touches) an operator 55 in which his or her name is described from this of the list of the plurality of operators 55. Accordingly, the operator OP who will actually operate the operation screen 30a of the operation device 30 can be selected. In other words, the action of selecting the operator 55 corresponds to the “operator identification information input action.”

Furthermore, the location where the operators 55 are displayed is not limited to the display section 52. For example, in the case where the display device 50 and the operation device 30 are configured as an integrated display in this embodiment, the operators 55 can be displayed in any section of the display (that is, any section of the display device 50 or any section of the operation screen 30a).

For example, to ensure security, in a case where the operator identification information, such as the operator name and password, is input into the operation device 30 (log in) when starting the use of the operation device 30, the information input at the time of login (login information) may be used as the operator identification information. In this case, the display of the operators 55 does not have to be performed.

FIG. 6 is one example of a flowchart for describing a series of processes from a start of video acquisition to a storage of video. Specifically, FIG. 6 illustrates a flowchart of the “specific control process” executed by the control module 950 according to this embodiment. In other words, the “specific control process” according to this embodiment includes Steps S10 to S40 described below. FIG. 6 is also a flowchart of the “video acquisition support method” executed by the control module 950 according to this embodiment.

At Step S10, the control module 950 starts the “video acquisition process” to acquire the video of the operation of the operation screen 30a when the operator OP operates the operation screen 30a of the operation device 30. For example, the control module 950 can start this video acquisition process when the operator OP operates (or clicks on) the operation icon 33 that corresponds to the “video acquisition start command” to start the video acquisition.

In this embodiment, the “video of the operation of the operation screen 30a” is specifically a video that includes images of the “the operation icons 33 on the operation screen 30a” operated by the operator OP. It is also preferable that this video further includes the images and the like that are displayed on the operation screen 30a when the operator OP operates the operation icon 33.

Specifically, at Step S10, the control module 950 acquires (that is, records) the operation screen 30a operated by the operator OP by the above-described “video capture process,” as one example.

To give a concrete example, for example, when the operator OP operates the plurality of operation icons 33 on the operation screen 30a in sequence to operate the substrate processing apparatus 1, the control module 950 acquires the operations of the plurality of operation icons 33 as the video at Step S10. More specifically, the control module 950 acquires, for example, the images of the plurality of operation icons 33 operated by the operator OP as the video in chronological order.

The specific operation contents of Step S10 are not limited to the above-described one. For example, at Step S10, the control module 950 may acquire the video of the operation of the operation screen 30a by having the operation of the operation screen 30a photographed by the shooting device 41.

In addition, at Step S10, the information on the operation contents of the operation screen 30a is transmitted to the control module 950. The control module 950 temporarily stores this information in the storage device 952, for example.

Next, the control module 950 ends the video acquisition process (Step S20). Specifically, the control module 950 ends the video acquisition process, for example, when the operator OP operates (or clicks on) the operation icon 33 corresponding to a “video acquisition end command” to end the video acquisition.

Next, the control module 950 executes the “meta information addition process” that adds predetermined meta information to the video acquired in the video acquisition process (Step S30). “Adding meta information to a video,” specifically means linking the video (specifically, the video information) with the meta information, in other words, associating the video with the meta information. In addition, it is preferable that, at Step S30, it is possible not only to add the meta information but also to modify the meta information.

In this embodiment, the “meta information” regarding Step S30 specifically includes at least the operation content (for example, the information on the operated operation icon 33) operated by the operator OP on the operation screen 30a. In other words, this meta information includes information on the type of the operation icon 33 operated by the operator OP, the information on the order of the operated operation icons 33, and the like.

In addition, the meta information may include information on a title of the acquired video. Specifically, in this case, when the operator OP inputs the title of the video acquired in the video acquisition process into the word input section 51 at Step S20, the control module 950 adds this input title to the video as the meta information at Step S30.

The meta information may also include information on the alarm. Specifically, in this case, the control module 950 adds the alarm that occurred while the operator OP was operating the operation screen 30a, to the video as the meta information.

In addition, the meta information may also include the information on the word used for a video search. Specifically, in this case, when the operator OP inputs a word for video search in the word input section 51 at Step S20, the control module 950 adds this input word for the video search as the meta information to the video at Step S30.

In addition, the meta information may also include information on the operator identification information. Specifically, in this case, when the operator OP inputs the operator identification information at Step S20, the control module 950 adds this input operator identification information to the video as the meta information at Step S30.

Next, at Step S40, the control module 950 executes a “video storage process” that stores the acquired video in the storage device 952 together with the meta information added to the video. Step S40 allows the video linked to the meta information to be stored (that is, store) in the storage device 952.

The control module 950 executes the series of steps (that is, “specific control process”) illustrated in the above-described FIG. 6 multiple times. Thus, the plurality of videos associated with the operations of the operation screen 30a are stored in the storage device 952.

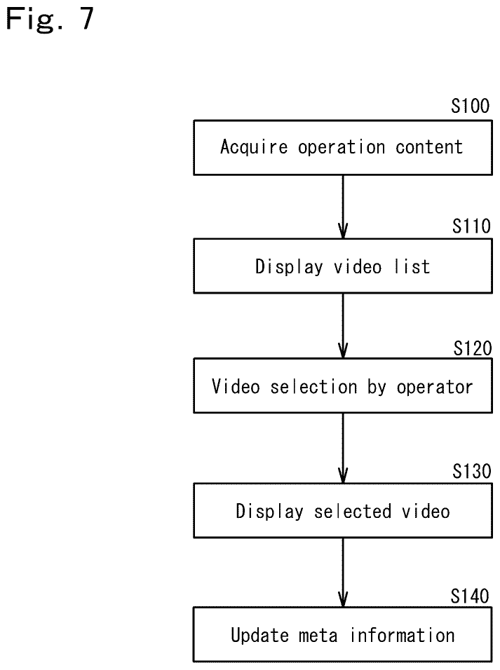

This allows the “way in which the operator OP (this includes a developer of the operation device 30) who is skilled in the operation of the operation device 30 operates the operation device 30” to be stored as the video. As a result, executing the flowchart illustrated in FIG. 7 described later allows an unskilled operator OP to watch this video. By doing this, the unskilled operator OP can easily operate the operation device 30 by referring to this video.

FIG. 7 is one example of a flowchart for describing the process for displaying the video on the display device 50. The flowchart in FIG. 7 may be executed, for example, when the operator OP is actually operating the operation screen 30a (for example, during training for the operation of the operation screen 30a by the operator OP).

At Step S100 in FIG. 7, the control module 950 executes an “operation content acquisition process” to acquire the operation contents of the operation screen 30a by the operator OP. To give one example, assume that the operator OP operates the operation icon 33 corresponding to the “transfer start command” to start the transfer of the substrate WF by the transfer robot 110 of the substrate processing apparatus 1. In addition, this operation of the operation icon 33 may include moving a pointer displayed on the screen to the operation icon 33 corresponding to an operation start command. In this case, at Step S100, the control module 950 acquires information that the operation icon 33 corresponding to this transfer start command has been operated.

To give another example, assume that the operator OP operates the operation icon 33 corresponding to the “restart command” for restarting the substrate processing by the substrate processing apparatus 1. In this case, at Step S100, the control module 950 acquires information that the operation icon 33 corresponding to this restart command has been operated.

Next, at Step S110, the control module 950 executes the “video list display process” to display a “video list” that includes at least one video related to the operation content of the operator OP acquired at Step S100, from among the plurality of videos stored in the storage device 952.

To give one example, when the operation icon 33 corresponding to the “transfer start command” is operated at Step S100, the control module 950 causes the display device 50 to display, as the video 53, the video with the added meta information related to the operation icon 33 corresponding to this transfer start command (see the left diagram in the above-described FIG. 4). To give another example, when the operation icon 33 corresponding to the “restart command” is operated at Step S100, the control module 950 displays the video with the added meta information related to the operation icon 33 corresponding to the restart command as the video 53 on the display device 50.

Next, at Step S120, the control module 950 acquires information on the selection of the video by the operator OP. Specifically, the operator OP selects a video that the operator OP desires to watch from among the list of the plurality of videos 53 displayed on the display device 50. At Step S120, the control module 950 acquires the type of video selected by the operator OP.

Next, at Step S130, the control module 950 executes the “selected video display process” to display the video selected by the operator OP at Step S120 on the display device 50. For example, referring to the above-described FIG. 4, when the operator OP selects the No. 1 video 53, then at Step S130, the control module 950 displays a video 54 corresponding to the selected No. 1 video 53 (that is, the selected video) on the display device 50.

Step S110, Step S120, and Step S130 are one example of a “video display process” that selects the video related to the operation content from among the plurality of videos stored in the storage device 952, based on the operation contents of the operation screen 30a operated by the operator OP and causes the display device 50 to display the video.

Referring to FIG. 7, at Step S140, the control module 950 may update the meta information. Specifically, in this case, the control module 950 adds, for example, “information related to view” including the number of times the video has been viewed, viewing history, and/or the like, as the meta information to the video that has been viewed and stores it in the storage device 952.

For example, at Step S100, when the operator OP inputs a word for video search (this includes a title of video) in the word input section 51, the control module 950 may acquire information on the input word at Step S100. In this case, the control module 950 may select the video related to the input word from the videos in the storage device 952 and display it as the video 53 at Step S110.

In addition, when the operator OP inputs the operator identification information at Step S100 (or, as described above, when the operator identification information is input when logging in to the operation device 30), the control module 950 may acquire this input operator identification information at Step S100. In this case, the control module 950 may select the video related to the input operator identification information and display it as the video 53 at Step S110. This allows the video 53 to be displayed according to the operator OP operating the operation screen 30a.

According to this embodiment as described above, the flowchart illustrated in the above-described FIG. 6 is executed. Thus, the video of the operation of the operation screen 30a of the operation device 30 by the operator OP can be stored in the storage device 952 together with the meta information including the operation content operated by the operator OP on the operation screen 30a. This allows the video of the operation of the operation screen 30a of the operation device 30 to be acquired effectively.

In addition, according to this embodiment, the flowchart illustrated in the above-described FIG. 7 is executed. Thus, the video related to the operation content can be displayed on the display device 50 based on the operation content of the operation screen 30a by the operator OP. This allows the operator OP to quickly learn the operation of the operation screen 30a of the operation device 30 by watching the video displayed on this display device 50 when operating the operation screen 30a of the operation device 30.

### (Modification 1)

In the above-described embodiment, the video acquisition support apparatus 40 may be configured to be able to load “external video.” This external video is, specifically, a video of the operation screen 30a of the operation device 30 operated by the operator OP, and is the video acquired by an external video acquisition device 40a (this numeral reference is illustrated in FIG. 2). This external video acquisition device 40a is a device that can acquire the video of the operation screen 30a of the operation device 30 operated by the operator OP in advance.

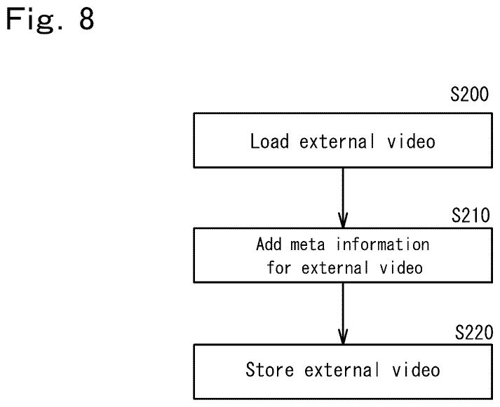

FIG. 8 is one example of a flowchart for describing a process for loading the external video according to this modification. At Step S200, the control module 950 according to this modification executes an “external video loading process” to load the external video.

Specifically, for example, when the operator OP operates the operation icon 33 corresponding to the “external video loading start command” to start loading the external video, it is sufficient that the control module 950 executes the external video loading process.

Specifically, at Step S200, the control module 950 can store the external video that the external video acquisition device 40a has previously acquired and stored in the external video acquisition device 40a, in the storage device 952 and/or the external storage device 23. Alternatively, when the external video is stored, for example, in the external storage device 23 before executing Step S200, the control module 950 may load the external video stored in this external storage device 23 into the storage device 952 at Step S200.

In addition, at Step S200, the control module 950 may further load data (which may include text data, image data, video data, or the like) related to an operation manual of the operation device 30, as well as the external video.

Alternatively, hypothetically, if the component device of the substrate processing apparatus 1 include a built-in camera or the like, and there are images taken with this built-in camera, the control module 950 may load these images. Alternatively, hypothetically, if the operator OP operates a technology such as augmented reality or mixed reality when operating the operation screen 30a of the operation device 30, the control module 950 may also load the images used when using augmented reality or mixed reality. These images are also one example of the external video.

Next, at Step S210, the control module 950 executes the “external video meta information addition process” to add the meta information for external video to the loaded external video.

This meta information for external video includes the similar information as the above-described meta information. Specifically, the meta information for external video includes the operation content (for example information on the operated operation icon 33) operated by the operator OP on the operation screen 30a when acquiring the external video.

The control module 950 may acquire this meta information for external video, for example, from the control module (computer) of the external video acquisition device 40a and add it to the external video.

Next, at Step S220, the control module 950 executes the “external video storage process” to store the loaded external video in the storage device 952 together with the meta information for external video added to the external video.

The control module 950 according to this modification selects the external video related to the operation content based on the operation contents of the operation screen 30a of the operation device 30 by the operator OP in, for example, the “video display process” corresponding to Step S110 to Step S130 of the above-described FIG. 7, and displays it on the display device 50. This allows the external video to be displayed on the display device 50 similarly to the video acquired in the above-described flowchart illustrated in FIG. 7.

According to the above-described modification, since it is possible to load the external videos, it is possible to effectively support the fast learning of the operation of the operation screen 30a of the operation device 30 by the operator OP.

As described above, while the details of the embodiments and modifications of the present invention have been described, the present invention is not limited to the specific embodiments and modifications, and various kinds of modifications and changes can further be made within the spirit of the present invention described in the claims.

### REFERENCE SIGNS LIST

1 . . . substrate processing apparatus
30 . . . operation device
30a . . . operation screen
40 . . . video acquisition support apparatus
50 . . . display device
950 . . . control module (or computer)
951 . . . processor (or computer)
952 . . . storage device
OP . . . operator

What is claimed is:

1. A video acquisition support apparatus for an operation device including an operation screen operated by an operator, comprising:
a control module configured to control the operation device, wherein
the control module executes a specific control process including:
a video acquisition process configured to acquire a video of an operation of the operation screen when the operator operates the operation screen of the operation device;
a meta information addition process configured to add meta information including at least an operation content operated by the operator on the operation screen to the acquired video; and
a video storage process configured to store the acquired video in a storage device together with the meta information added to the video.

2. The video acquisition support apparatus according to claim 1, wherein
the control module executes:
the specific control process a plurality of times to store a plurality of the videos in the storage device; and
a video display process in which the video related to the operation content is selected from among the plurality of videos stored in the storage device based on the operation content operated by the operator on the operation screen and displayed on a display device.

3. The video acquisition support apparatus according to claim 2, wherein
the display device is configured to allow inputting of word,
the meta information includes the word inputted, and
the control module selects the video related to the word inputted and displays on the display device in the video display process.

4. The video acquisition support apparatus according to claim 2, wherein
the display device is configured to allow input of operator identification information for identifying the operator who operates the operation device,
the meta information includes the operator identification information, and
the control module selects the video related to the operator who operates the operation screen of the operation device based on the operator identification information in the video display process and displays on the display device.

5. The video acquisition support apparatus according to claim 1, wherein
the control module further executes an external video loading process configured to load an external video as a video of the operation of the operation screen of the operation device by the operator acquired by an external video acquisition device.

6. A video acquisition support method for an operation device including an operation screen operated by an operator, comprising:
executing, by a control module configured to control the operation device, a video acquisition process configured to acquire a video of an operation of the operation screen when the operator operates the operation screen of the operation device;
executing, by the control module, a meta information addition process configured to add meta information including at least an operation content operated by the operator on the operation screen to the acquired video; and
executing, by the control module, a video storage process configured to store the acquired video in a storage device together with the meta information added to the video.

7. A non-transitory storage medium configured to store a program that causes a computer to execute a specific control process, the specific control process comprising:
a video acquisition process configured to acquire a video of an operation of an operation screen when an operator operates the operation screen of an operation device;
a meta information addition process configured to add meta information including at least an operation content operated by the operator on the operation screen to the acquired video; and
a video storage process configured to store the acquired video in a storage device together with the meta information added to the video.
